(19) United States
(12) Patent Application Publication
(10) Pub. No.: US 2015/0120483 A1
(43) Pub. Date: Apr. 30, 2015

(54) WIRELESS COMMUNICATION SYSTEM, MOBILE TERMINAL DEVICE, AND PROGRAM FOR USE IN MOBILE TERMINAL DEVICE

(71) Applicants: RASIS SOFTWARE SERVICE CO., LTD., Osaka (JP); QUEST JAPAN CO. LTD., Kishiwada-shi (JP)

(72) Inventors: Itsuji Ono, Osaka (JP); Hideyuki Torii, Osaka (JP)

(73) Assignee: QUEST JAPAN CO. LTD., Osaka (JP)

(21) Appl. No.: 14/403,066

(22) PCT Filed: Feb. 26, 2013
(86) PCT No.: PCT/JP2013/054921

§ 371 Date: Nov. 21, 2014

(30) Foreign Application Priority Data
Dec. 4, 2012 (JP) 2012-265508

(51) Int. Cl. G06Q 30/08

(52) U.S. Cl. CPC G06Q 30/08
USPC 705/26.3

(57) ABSTRACT

A mobile terminal server (40) distributes information on an item put up for auction at an auction venue and bid price information to a smartphone (11), and every time the information on the item is changed, transmits empty data as well as a bid price that is automatically raised by a server (30) until it reaches the lowest acceptable price. The smartphone (11) receives the distributed bid price information and displays the bid price on a display unit (113). If the displayed bid price is a desired price, the user selects a participate mode, and places a bid by operating a place bid key (B3). The smartphone (11) maintains communication with the mobile terminal server (40) as long as empty data is transmitted. This prevents communication from being suspended and prevents a delay in display.

### TECHNICAL FIELD

The present invention relates to wireless communication system for general user to participate in auctions of items such as used cars by using, e.g., a smartphone or a tablet terminal device, mobile terminal device, and program for use in mobile terminal device.

### BACKGROUND ART

An example of a method for conducting electronic auctions by using a personal computer (hereinafter referred to as the “PC”) is a method described in Japanese Unexamined Patent Application Publication (Japanese Translation of PCT Application) No. 2004-508637. In this example, a plurality of bidders capable of providing necessary articles or services are selected, and these bidders are notified of time and an auction period that has been prepared and permitted. An auction is conducted at the designated time, and each bidder can have his/her bid displayed during the permitted period. Each bidder has at least bids of anonymous competitors and the remaining time of the auction displayed. In order to compare the bids of the individual bidders, life cycle cost as a value for comparison is calculated online for each bid as a function of the bid price and another appropriate reference for decision. In this case, the auction is extended for at least a preset period.

In the electronic auctions described in Japanese Unexamined Patent Application Publication (Japanese Translation of PCT Application) No. 2004-508637, bidders are limited to vendors who can be involved in auctions. For example, even if ordinary people wish to put their own cars up for used car auctions, they can only put them up for Internet auctions, and cannot put them up for auctions that are held by used car dealers.

On the other hand, smartphones and tablet terminal devices have been increasingly used in recent years, and users can use the Internet anywhere. It is therefore possible for general users to participate in auctions with smartphones or tablet terminal devices by installing auction application software thereon. In auctions, the user typically places a bid on an item by entering a bid price using keys. However, it is troublesome and time-consuming to enter a bid price using keys, and other users may place a bid first if the user has trouble entering a bid price.

It is therefore an object of the present invention to provide a wireless communication system for auctions which allows ordinary people to enter a bid price by merely operating a key, a mobile terminal device, and a program for use in the mobile terminal device.

### SUMMARY OF INVENTION

The present invention is directed to a wireless communication system for a registered user to wirelessly communicate with a server by using a mobile terminal device to search for an item put up for auction and place a bid, wherein the server includes information transmitting unit for transmitting information on the item put up for auction and bid price information to the mobile terminal device by wireless communication, and every time the item is changed, changing a bid price at predetermined time intervals and transmitting the changed bid price to the mobile terminal device.

The mobile terminal device includes transmitting/receiving unit for receiving the information on the item and the bid price information which are distributed from the server by wireless communication, and transmitting bid command information when placing a bid on the item, display unit for displaying the bid price based on the bid price information received by the transmitting/receiving unit, and input unit for designating the item and outputting the bid command information to the transmitting/receiving unit in order to place a bid on the item at the bid price displayed on the display unit.

The bid price is automatically updated and displayed on the mobile terminal device at the predetermined time intervals. Therefore, the user can place a bid by merely sending a simple command to place a bid, such as inputting a key, when a desired bid price is displayed.

More preferably, the server includes empty data output unit for transmitting predetermined empty data when the bid price information is transmitted from the information transmitting unit, and the mobile terminal device includes communication maintaining unit for maintaining wireless communication with the server if it is determined that the empty data has been transmitted by the transmitting/receiving unit.

Communication between the mobile terminal device and the server can be maintained by transmitting the empty data. Accordingly, even if the display intervals of the bid price are extended, a delay can be prevented from being caused when the bid price is changed and displayed.

More preferably, the server automatically raises the bid price at regular intervals until it reaches a predetermined bid price, and stops raising the bid price when it reaches the predetermined bid price.

A minimum sale price for the item is decided in advance, and the bid price is quickly raised at short time intervals until it gets closer to the minimum sale price, and the bid price stops being automatically raised when it reaches the minimum sale price. This allows the user to place a bid at the price at which the bid price stops being raised.

More preferably, the mobile terminal device includes current location detecting unit for detecting a current location of the mobile terminal device and outputting current location information, and the transmitting/receiving unit transmits the current location information output from the current location information detecting unit to the server.

Transmitting the current location information to the server allows the location where the user placed a bid to be managed.

More preferably, the server counts the number of accesses to each item based on the bid command information transmitted from a plurality of the mobile terminal devices, and transmits access information to each mobile terminal device, and the mobile terminal device displays on the display unit an access ranking of the items based on the access information.

A distribution index of the item the user wishes to place a bid on can thus be known.

Another aspect of the present invention is directed to a mobile terminal device for wirelessly communicating with a server that distributes information on an item put up for auction and bid price information by wireless communication, and every time the item is changed, changes a bid price at predetermined time intervals, so that a registered user searches for the item and place a bid.

The mobile terminal device includes; transmitting/receiving unit for receiving the information on the item and the bid price information which are distributed from the server by wireless communication, and transmitting bid command information when placing a bid on the item; display unit for displaying a bid price based on the information on the item and the bid price information which are received by the transmitting/receiving unit; and input unit for designating the item and outputting the bid command information to the transmitting/receiving unit in order to place a bid on the item at the bid price displayed on the display unit.

More preferably, the server transmits the bid price information and transmits predetermined empty data from the information transmitting unit, and the mobile terminal device further includes; communication maintaining unit for maintaining wireless communication with the server if it is determined that the empty data has been transmitted by the transmitting/receiving unit.

More preferably, the mobile terminal device further includes; current location detecting unit for detecting a current location of the mobile terminal device and outputting current location information, and the transmitting/receiving unit transmits the current location information output from the current location information detecting unit to the server.

Still further aspect of the present invention is directed to a program for use in a wireless communication system for wirelessly communicating with a server by using a mobile terminal device to search for an item put up for auction and place a bid.

The program for use in the mobile terminal device causes the mobile terminal device as a computer to function as detecting mean for detecting reception of empty data by monitoring a communication status between the mobile terminal device and the server, and as communication unit for maintaining wireless communication between the mobile terminal device and the server in response to detection of the empty data by the detecting unit.

A further aspect of the present invention is directed to a program for use in a mobile terminal device in a wireless communication system for wirelessly communicating with a server by using the mobile terminal device to search for an item put up for auction and place a bid.

The program causes the mobile terminal device as a computer to function as communication maintaining mean for monitoring a communication status between the mobile terminal device and the server, and performing wireless communication between the mobile terminal device and the server and maintaining wireless communication with the server if bid price information is not updated after reception of information on the item and the bid price information.

By installing this program on the mobile terminal device, anyone can participate in auctions with the mobile terminal device.

### BRIEF DESCRIPTION OF DRAWINGS

FIG. 1 is a block diagram showing a wireless communication system for running a program for electronic auctions according to an embodiment of the present invention.

FIG. 2 is a schematic block diagram of a smartphone 11 shown in FIG. 1.

FIG. 3 is a schematic block diagram of a mobile terminal server 40 shown in FIG. 1.

FIG. 4 is a diagram showing an operation screen of the smartphone 11 in FIG. 1.

FIG. 5 is a flowchart illustrating operation of the mobile terminal server 40 according to the embodiment of the present invention.

FIG. 6 is a flowchart illustrating operation of the smartphone 11 according to the embodiment of the present invention.

FIG. 7 is a diagram illustrating the reason why a delay in displaying a price can be eliminated.

FIG. 8 is a diagram illustrating the timing of transmitting empty data.

### DESCRIPTION OF EMBODIMENTS

An embodiment of the present invention will be described with reference to the accompanying drawings.

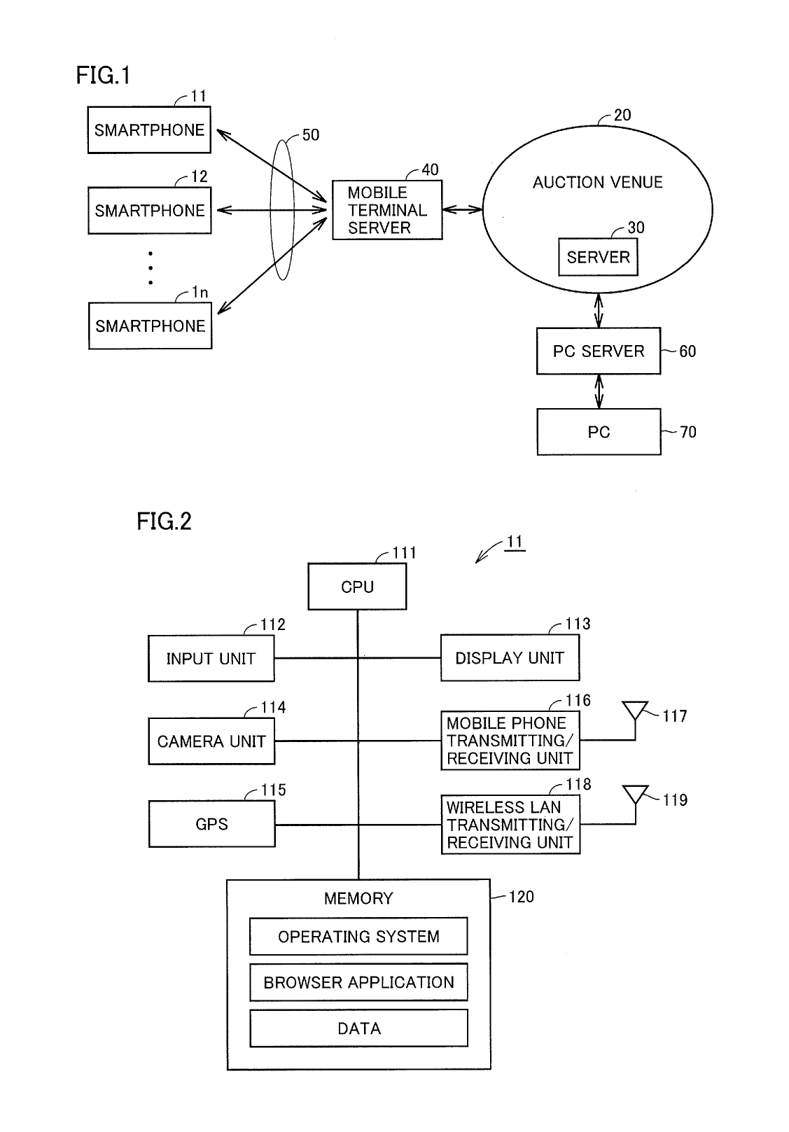

FIG. 1 is a block diagram showing a wireless communications system for running a program for electronic auctions according to an embodiment of the present invention. Items that are put up for auction may be used cars, electronic devices, flowers, meat as an example of food, or other things. The following description is given with respect to an example in which a used car is going to be sold by auction.

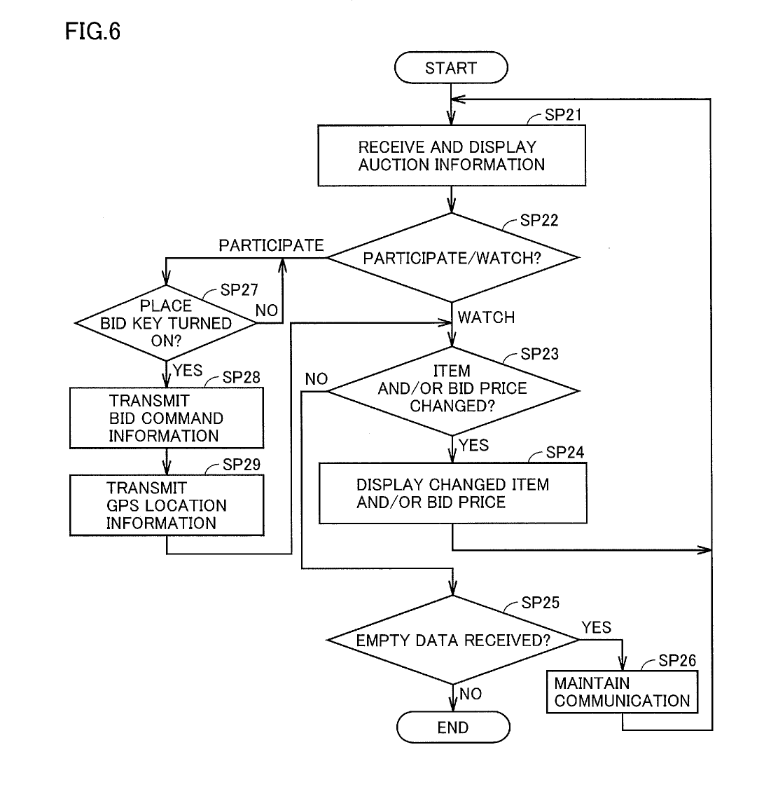

A user who is a customer as well as a final buyer who wishes to purchase a used car as an auction item has any one of smartphones 11, 12, . . . , 1n as an example of a mobile terminal device. Identification information such as ID and a password is sent in advance to the smartphones 11, 12, . . . , 1n by contract with an auctioneer etc., and an application software program based on the flowchart shown in FIG. 6 described below is installed in advance on the smartphones 11, 12, . . . , 1n in order to run electronic auctions. The mobile terminal device is not limited to the smartphones 11, 12, . . . , 1n, and may be a mobile tablet terminal device. Bidders using the mobile terminal device may not be ordinary people, and may be limited to used car dealers.

A server 30 that distributes auction information including information on items such as used cars and bid price information is installed at an auction venue 20. A mobile terminal server 40 and a personal computer (PC) server 60 are connected to the server 30. The smartphones 11, 12, . . . , 1n are connected to the mobile terminal server 40 via an Internet network 50 such as, e.g., 3G/LTE lines. A personal computer (PC) 70 is connected to the PC server 60. The auction information including information on the items and bid price information is distributed from the server 30 at the auction venue to the mobile terminal server 40 and the personal computer (PC) server 60. Auction participants can participate in auctions not only by using the smartphones 11, 12, . . . , 1n but also by using the PC 70. The server 30, the mobile terminal server 40, and the PC server 60 may be integrated.

Information on the items is prepared according to types of items that are put up for auction. If the items are used cars, information on the used cars is prepared. If the items are other than used cars, information corresponding to these items is prepared. After the information on each item is distributed, bid price information on each item is distributed. The bid price information is changed so that the bid price increases at predetermined intervals. The information on each item can be any information that can be distributed to the smartphones 11, 12, . . . , 1n, and includes a photo of the used car and information such as manufacturer, make, body color, interior color, registration date, mileage, any car options, and any accident history of the used car. Every time the information on the used cars that are put up for auction at the auction venue is changed, the server 30 outputs the updated information on the used cars to the mobile terminal server 40 and the PC server 60, and the mobile terminal server 40 distributes the updated information on the used cars to the smartphones 11, 12, . . . , 1n.

With any one of the smartphones 11, 12, . . . , 1n, the user can browse through used cars put up for auction at the auction venue 20 while being at home etc. away from the auction venue 20. For example, if the user operates the smartphone 11 to run application software for electronic auctions, information on used cars that are put up for auction is sent from the auction venue to each smartphone 11, 12, . . . , 1n. This information is displayed on the screen of the smartphone 11. Since the user can look at the information on the used cars on the screen of the smartphone 11, he/she can search for a desired used car as if he/she were at the auction venue 20 of the used cars, without actually going to the auction venue 20. If there is any used car the user wishes to purchase as a result of the search, he/she can place a bid on that used car.

FIG. 2 is a schematic block diagram of the smartphone 11 shown in FIG. 1. The other smartphones 12, . . . , 1n are also configured similarly. In FIG. 2, the smartphone 11 is a multi-function mobile phone having a personal digital assistant (PDA) function, and includes a CPU 111 that operates as communication maintaining unit, an input unit 112 that operates as input unit, a display unit 113 that operates as display unit, a camera unit 114, a GPS 115 that operates as current location detecting unit, a mobile phone transmitting/receiving unit 116 that operates as transmitting/receiving unit, a mobile phone antenna unit 117, a wireless LAN transmitting/receiving unit 118, a wireless LAN antenna unit 119, and a memory 120.

The CPU 111 controls each function according to a program that is stored in the memory 120. The program includes a browser application and an operating system. The memory 120 has an area for storing data in addition to an area for storing the program. The CPU 111 can perform processing according to the browser application stored in the memory 120 to obtain data from the mobile terminal server 40, to store the data in the memory 120, and to display an image represented by the data in the memory 120 on the display unit 113. The operating system is a program that provides basic functions that are used for the browser application.

The mobile phone transmitting/receiving unit 116 wirelessly communicates with a base station, not shown, via the mobile phone antenna unit 117. The wireless LAN transmitting/receiving unit 118 transmits and receives a digital signal forming various data to and from the mobile terminal server 40 via an access point, not shown, from the wireless LAN antenna portion 119. The input unit 112 is realized by keys for sending a command to perform each function of the smartphone 11. The display unit 113 displays various function information of the smartphone 11.

The memory 120 may be formed by combining a random access memory (RAM), a read only memory (ROM), a flash memory, a hard disk drive (HDD), etc.

The GPS 115 measures a current location of the smartphone 11 by a global positioning system (GPS), and the CPU 111 transmits information on the measured current location from the mobile phone transmitting/receiving unit 116 to the mobile terminal server 40 via the mobile phone antenna unit 117. An office at the auction venue 20 knows the location where the user is participating in the auction, based on the current location information received from the mobile terminal server 40 via the server 30.

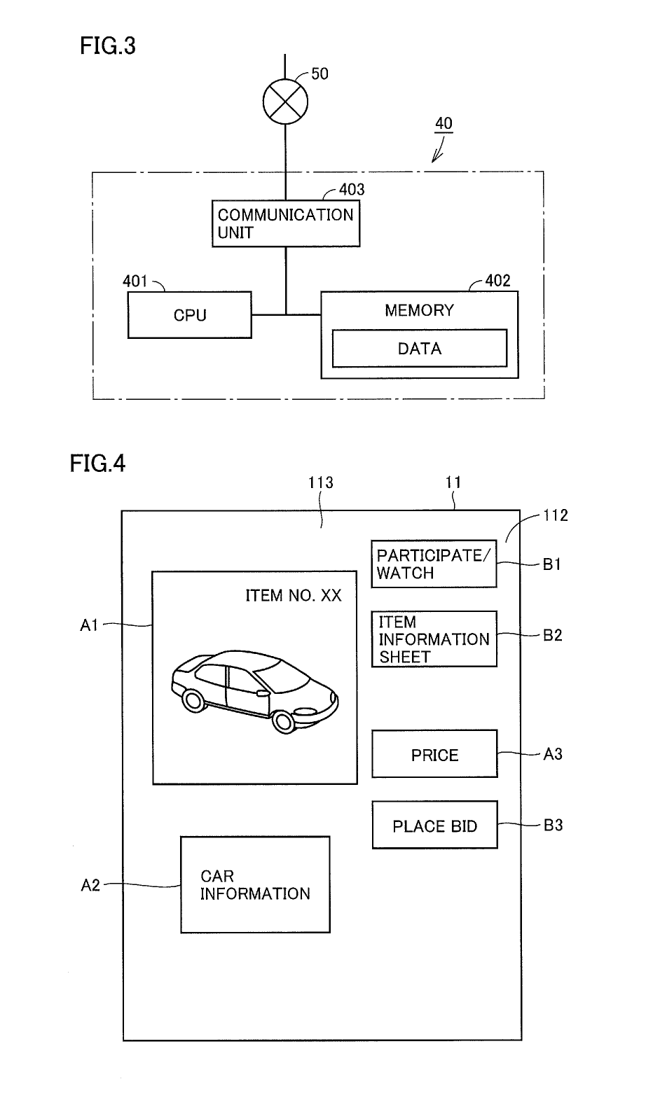

FIG. 3 is a block diagram of the mobile terminal server 40 shown in FIG. 1. The configuration of the mobile terminal server 40 will be described with reference to FIG. 3. The mobile terminal server 40 includes a CPU 401 that mainly operates as information transmitting unit and empty data output unit, a memory 402, and a communication unit 403. The mobile terminal server 40 is a device that provides data held therein and various functions to the smartphone 11 via the Internet network 50. The CPU 401 controls each function. The memory 402 stores data therein. The communication unit 403 transmits and receives various information to and from the smartphone 11 etc. via the Internet network 50.

The CPU 401 distributes updated data from the communication unit 403 to the smartphones 11, 12, . . . , 1n via the Internet network 50 as auction information on used cars.

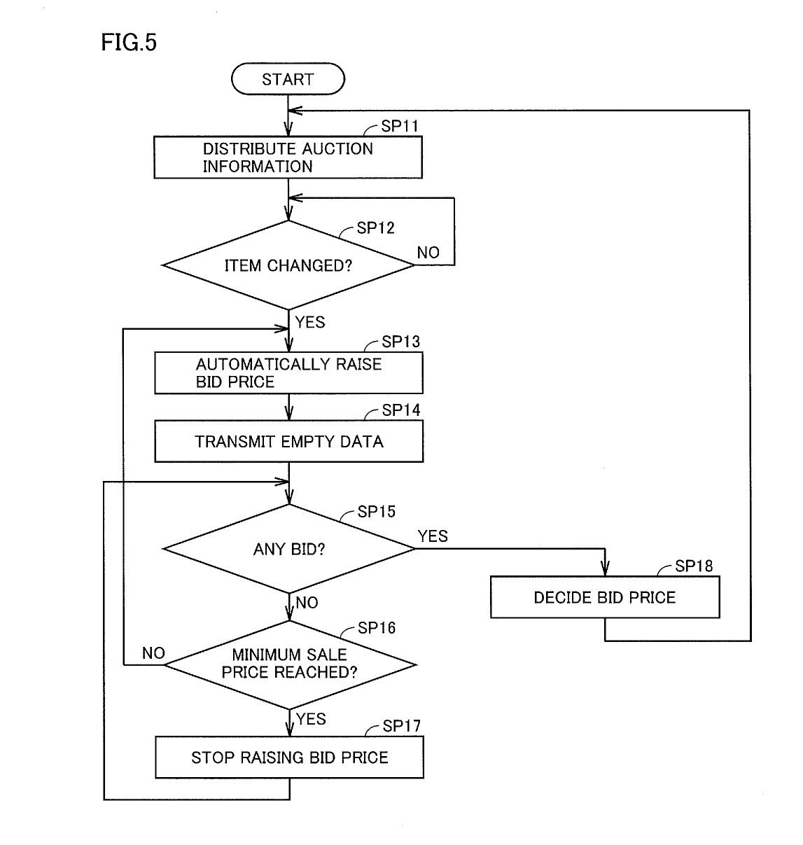

FIG. 4 is a figure showing the input unit 112 and the display unit 113 of the smartphone 11. The display unit 113 of the smartphone 11 is, e.g., an LCD panel, and includes an area A1 that displays an image of the whole used car put up for auction, an area A2 that displays general information such as make of the used car, and an area A3 that displays a bid price that changes at every moment. The input unit 112 is formed by a touch panel formed integrally with the display unit 113, and includes a mode key B1 that switches between participating in the auction and just watching the auction, an item information sheet key B2 that sends a command to display detailed data of the used car put up for auction, and a place bid key B3 that sends a command to place a bid.

The bid price is set by the server 30 so as to be automatically raised, e.g., every 40 msec in increments of, e.g., 3,000 yen from an initial price to a reserve price as a minimum sale price, and is transmitted to the smartphone 11 via the mobile terminal server 40. The initial price can be set by the server 30 to any price that is desired by the seller of the used car. Sellers sometimes do not wish bids on their items to be too low. Therefore, the bid price is automatically raised every 40 msec until it reaches the minimum sale price. When the bid price gets higher than the minimum sale price, the bid price stops being automatically raised. Subsequently, if the user operates the place bid key B3, the sum of the bid price at that time and, e.g., 3,000 yen is decided as the bid price. The amount to be added to the bid price is not limited to 3,000 yen, and may be any amount. Alternatively, no amount may be added to the bid price, and a command to place a bid at the minimum sale price may be sent.

FIGS. 5 and 6 are flowcharts illustrating an operation of running a program for electronic auctions according to an embodiment of the present invention. FIG. 5 shows an operation of the mobile terminal server 40, and FIG. 6 shows an operation of the smartphone 11.

In step (hereinafter simply referred to as “SP”) SP11 shown in FIG. 5, the CPU 401 of the mobile terminal server 40 distributes, as auction information, information on the item and bid price information to the smartphones 11, 12, . . . , 1n, based on information on the used car stored as data in the memory 402. For example, the mobile phone transmitting/receiving unit 116 of the smartphone 11 receives the distributed information, i.e., the information on the item and the bid price information, via the mobile phone antenna unit 117.

In SP21 shown in FIG. 6, the CPU 111 of the smartphone 11 stores the received auction information in the memory 120, and displays the distributed information, i.e., the information on the item and the bid price information, on the display unit 113 shown in FIG. 4. An image of the appearance of the used car together with its item number is displayed on the area A1 of the display unit 113, and the make etc. of the used car is displayed as the information on the used car on the area A2. A bid price is displayed on the area A3. The user selects the watch mode with the mode key B1 if he/she is going to just watch the bidding status of the auction of the used car, and selects the participate mode with the mode key B1 if he/she is going to participate in bidding on the auction.

In SP12, the CPU 401 of the mobile terminal server 40 determines whether the item has been changed or not. Since the information on the changed item is written from the server 30 installed at the auction venue to the memory 402 of the mobile phone server 40, it can be easily determined whether the item has been changed or not. If the item has been changed, the CPU 401 of the mobile terminal server 40 transmits the price information received from the server 30, i.e., the price information that is automatically raised every 40 msec in increments of 3,000 yen, to the smartphone 11 in SP13.

In SP14, the CPU 401 of the mobile terminal server 40 transmits empty data, e.g., every 100 msec. Empty data is transmitted every 100 msec because there is a possibility that it may be determined that communication has been suspended if the bid price information is transmitted at intervals of 100 msec or more. As described above, the bid price is automatically raised every 40 msec until it reaches the minimum sale price. However, it may take 1 sec or more for the user to send a command to place a bid after the bid price gets higher than the minimum sale price. Empty data is therefore transmitted so that communication is not suspended.

Empty data may not be transmitted in the case where there is no possibility that it may be determined that communication has been suspended even if the bid price information is transmitted at intervals of 100 msec. Empty data may be transmitted if the time interval at which it may be determined that communication has been suspended is reached. However, since the time interval at which it is determined that communication has been suspended is unknown, the bid price information is transmitted every 40 msec, and empty data is transmitted every T≧100 msec in the present embodiment.

As used herein, the term “empty data” refers to meaningless data having successive pieces of data “1” within a predetermined packet, having successive pieces of data “0” within a predetermined packet, or formed by combination of any number of pieces of data “1” and “0” within a predetermined packet. The configuration of empty data is predetermined so that the smartphone 11 can easily recognize that it is empty data.

In SP15, the CPU 401 determines whether any bid has been placed or not. If no bid has been placed, the CPU 401 determines in SP16 whether the minimum sale price has been reached or not. The minimum sale price is an arbitrary price that is decided by the seller. If the minimum sale price has not been reached, the routine returns to SP13 to automatically raise the bid price. If it is determined in SP16 that the minimum sale price has been reached, the bid price stops being automatically raised in SP17. By the operations of SP13 to SP17, the bid price is automatically raised from the initial bid price and transmitted every 40 msec and empty data is transmitted every 100 msec from the mobile terminal server 40 to the smartphone 11.

The user selects the watch mode with the mode key B3 when he/she is going to watch the auction. In SP21 of FIG. 6, the CPU 111 of the smartphone 11 receives the auction information and displays the bid price on the area A3. In SP22, the CPU 111 determines whether the selected mode is the watch mode or the participate mode. If it is determined that the selected mode is the watch mode, the CPU 111 determines in SP23 whether one or both of the item and the bid price have been changed or not. If one or both of the item and the bid price have been changed, the changed item and/or bid price is displayed in SP24, and the routine returns to SP21. By this series of operations, the bid price is displayed on the area A3 of the display unit 113 of the smartphone 11 so as to be automatically raised from, e.g., 30,000 yen as an initial bid price in increments of 3,000 yen. If it is determined in SP23 that there is no change in the information on the item and the bid price information, the CPU 111 determines in SP25 whether it has received empty data together with the bid price transmitted from the server 30 or not. Whether the received data is empty data or not is determined by determining whether data in a predetermined packet forms predetermined empty data or not. If it is determined in SP25 that the CPU 111 has received empty data, the CPU 111 maintains communication in SP26, and the routine returns to SP21 to display information on the subsequent item and a bid price of this item. If it cannot be determined in SP25 that the CPU 111 has received empty data, communication is cut off. However, communication may be maintained as it is. The CPU 11 may check if it has received empty data or not when the changed item and/or bid price are displayed in SP24.

Since empty data is thus transmitted after the bid price information is transmitted from the mobile terminal server 40, communication between the smartphone 11 and the mobile terminal server 40 is maintained and is prevented from being suspended.

An image of the used car as a current item continues to be displayed as a still image on the area A1 of the display unit 113. Alternatively, a message such as “waiting for update of auction information” may be displayed on the area A1 of the display unit 113.

If the user is going to participate in bidding at the bid price displayed on the area A3, he/she operates the mode key B1 to send a command to place a bid. If it is determined in SP22 that the selected mode is the participate mode, the CPU 111 of the smartphone 11 determines in SP27 whether the place bid key B3 has been turned on or not. If it is determined that the place bid key B3 has been turned on, the item number of the used car displayed on the area A1 is transmitted as bid command information to the mobile terminal server 40 in SP28. Moreover, in SP29, the CPU 111 transmits current location information of the smartphone 11 detected by the GPS 115. A bid is thus placed on the used car that the user wants to buy. Then, the subsequent item is displayed in SP23.

If a bid has been placed with the smartphone 11, the CPU 401 of the mobile terminal server 40 determines in SP15 that a bid has been placed, and specifies the bid price and the bidder in SP18. If the bid price being automatically raised has not reached the minimum sale price, the bid price is the price at that point. If the bid price has reached the minimum sale price, the sum of the minimum sale price and, e.g., 3,000 yen is decided as the bid price. The bidder can be easily identified from an ID and a password which have been entered with the smartphone 11.

If the amount at the time the place bid key B3 is turned on is much lower than the minimum sale price desired by the seller, it may be determined that the seller will reject the bid, and this information may be transmitted to the smartphone 11.

Suspension mentioned above will be described. Suspension occurs during a period from the time bid price information is transmitted by the server 30 to the time the smartphone 11 receives and displays that bid price information due to a communication line. Suspension is caused by the time it takes to establish connection to start communication and the time required for data transfer.

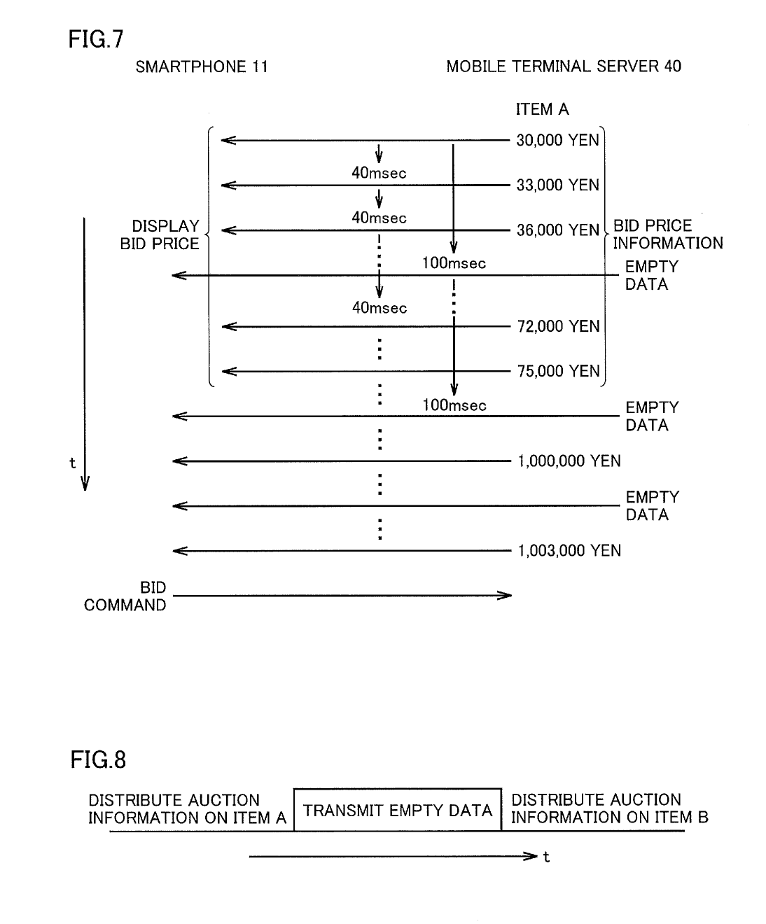

As shown in FIG. 7, regarding, e.g., an item A such as a used car, bid price information is output from the server 30 via the mobile terminal server 40 so that a bid price is automatically raised at regular time intervals (e.g., 40 msec) from 30,000 yen in increments of 3,000 yen. The smartphone 11 receives this bid price information and displays the bid price. The user places a bid at the displayed bid price by operating the place bid key B3, until the displayed bid price reaches a minimum sale price (e.g., a million yen). In this case, the user can place a bid lower than the minimum sale price. However, the seller can reject the bid if it is lower than the minimum sale price.

It is now assumed that the user sends a command to place a bid a few seconds after the minimum sale price is displayed. If there is an interval of several seconds, the smartphone 11 determines that communication has been suspended. Accordingly, the screen of the smartphone 11 goes black, and the user cannot place a bid. The auction screen can be displayed again by key input, but the time it takes to establish connection to start communication and the time required for data transfer cause a delay in displaying the bid price.

In the present embodiment, however, even if a command to place a bid is sent a few seconds after the minimum sale price is displayed, empty data is transmitted every 100 msec during this period. Accordingly, even if the display intervals of the bid price are increased from 40 msec to as long as a few seconds, the smartphone 11 determines that communication with the mobile terminal server 40 has been maintained, and therefore communication is not suspended.

As shown in FIG. 8, after bidding is conducted on the item A, bid price information on the subsequent item B is sometimes distributed from the server 30 to the smartphone 11 via the mobile terminal server 40 after a predetermined suspension period. The mobile terminal server 40 continues to transmit empty data even after the bid price and the bidder are specified in SP18. The smartphone 11 therefore maintains communication for as long as it receives the empty data. Accordingly, no delay is caused in displaying a bid price for the subsequent item B. The mobile terminal server 40 stops transmitting the empty data when the auction is finished.

As described above, in the present embodiment, the bid price is displayed so as to be automatically raised, and the user can participate in the bidding by merely operating the place bid key B3 when a desired amount is displayed. Moreover, the mobile terminal server 40 transmits empty data as well as bid price information to the smartphone 11. Therefore, even if the bid price information is transmitted at an increased time interval, communication is prevented from being suspended, and communication can be maintained.

The time required to establish connection to start communication is therefore not necessary. Accordingly, even if the user manually enters a bid price, a delay in distributing the subsequent auction information can be prevented. Even if an auction of the subsequent used car is started, an initial bid price is displayed, and the user can therefore start placing a bid from an initial stage of the auction of the subsequent used car. This can eliminate a situation in which the user can only start placing a bid at a price higher than the initial bid price.

The bid price is changed at regular intervals of 40 msec. This is because there is a possibility that it may be determined that communication has been suspended if the bid price is changed at intervals of T≦100 msec. It is therefore desirable to change the bid price at intervals of 100 msec or less. The time intervals may be adjustable.

If the bid price gets higher than the lowest acceptable price, it stops being automatically raised. If a plurality of users send commands to place a bid at this time, the first one to send a command is specified as a bidder.

The smartphone 11 includes the GPS 115. If the user sends a command to place a bid, location information obtained by the GPS 115 is sent to the office at the auction venue 20. This location information allows the office to immediately know the location where the user is placing a bid. The office can therefore manage the location where the user is participating in the auction. Managing the location where the user placed a bid can avoid such a situation that the user insists that he/she didn't place a bid etc. In particular, since the user is participating in the auction with the smartphone 11, 12, . . . , 1n without being at the auction venue 20, the office cannot directly manage the user participating in the auction. This tends to cause trouble due to the difference in perception between the office and the auction participant. However, knowing the location of the user can reduce such a problem. The location information may not be sent at the time the user places a bid, but may be transmitted from the smartphone 11 to the mobile terminal server 40 in response to reception of the auction information.

Detailed information on the used car displayed on the area A1 can be displayed by operating the item information sheet key B2.

The smartphone 11 may have a function to display as a used car distribution index an access ranking of the used car the user searched for according to the auction information distributed from the mobile terminal server 40 among auction vehicles. This function can provide a new index to used car distribution indices provided to the user.

The user needs to stop participating in the used car auction if he/she receives a call while participating in the auction. Accordingly, when participating in auctions, the user may turn off incoming call notifications on the screen as necessary by operating a key by using a call transfer function.

Moreover, 800,000 yen close to the minimum sale price (the amount lower than one million yen as the lowest acceptable price by 20%) may be set in advance, and the bid price may be quickly raised from, e.g., 500,000 yen (50% of one million yen as the lowest acceptable price) at intervals of 40 msec. As the bid price gets closer to 800,000 yen close to the minimum sale price, the time intervals at which the bid price is raised may be increased to, e.g., 100 msec to 500 msec, and the bid price may stop being raised when it gets higher than the minimum sale price.

The smartphone 11 may have a function to allow the user to immediately call the auction venue by operating a predetermined key.

The plurality of smartphones 11, 12, . . . , 1n may simultaneously access the mobile terminal server 40 to participate in an auction. In this case as well, bid price information and empty data are transmitted to smartphones 11, 12, . . . , 1n simultaneously.

### INDUSTRIAL APPLICABILITY

The present invention can be used by general users to watch auctions of used cars or participate in bidding at home etc. with a smartphone or a tablet terminal device without actually going to an auction venue.

### Reference Signs List

11, 12, . . . , 1n smartphone

20 auction venue

30 server

40 mobile terminal server

111, 401 CPU

112 input unit

113 display unit

114 camera unit

115 GPS

116 mobile phone transmitting/receiving unit

117 mobile phone antenna unit

118 wireless LAN transmitting/receiving unit

119 wireless LAN antenna unit

120, 402 memory

403 communication unit

B1 mode key

B2 item information sheet key

B3 place bid key

1. A wireless communication system for a registered user to wirelessly communicate with a server by using a mobile terminal device to search for an item put up for auction and place a bid, wherein
said server includes an information transmitting unit for transmitting information on said item put up for auction and bid price information to said mobile terminal device by wireless communication, and every time said item is changed, automatically changing a bid price at predetermined time intervals and transmitting said changed bid price to said mobile terminal device
said mobile terminal device includes
a transmitting/receiving unit for receiving said information on said item and said bid price information which are distributed from said server by wireless communication, and for transmitting bid command information when placing a bid on said item,
a display unit for displaying said bid price based on said bid price information received by said transmitting/receiving unit, and
an input unit for designating said item and outputting said bid command information to said transmitting/receiving unit in order to place a bid on said item at said bid price displayed on said display unit,
said server further includes an empty data output unit for transmitting predetermined empty data to said mobile terminal device when said bid price information is transmitted from said information transmitting unit, and
said mobile terminal device includes a communication maintaining unit for maintaining wireless communication with said server if it is determined that said empty data has been received by said transmitting/receiving unit.

2. (canceled)

3. The wireless communication system according to claim 1, wherein
said server is configured to automatically raise said bid price at said predetermined time intervals until said bid price reaches a predetermined minimum sale price, and to stop raising said bid price when said bid price reaches said minimum sale price.

4. The wireless communication system according to claim 1, wherein
said mobile terminal device includes a current location detecting unit for detecting a current location of said mobile terminal device and for outputting current location information, and
said transmitting/receiving unit is configured to transmit said current location information output from said current location detecting unit to said server.

5. The wireless communication system according to according to claim 1, wherein
said server is configured to count a number of accesses to each item based on said bid command information transmitted from a plurality of said mobile terminal devices, and to transmit access information to said each mobile terminal device, and
said mobile terminal device is configured to display on said display unit an access ranking of said items based on said access information.

6. A mobile terminal device for wirelessly communicating with a server that distributes information on an item put up for auction and bid price information by wireless communication, and every time said item is changed, changes a bid price at predetermined time intervals, so that a registered user searches for said item and places a bid, wherein
said mobile terminal device is configured to receive said bid price information and to receive predetermined empty data transmitted from said server, said mobile terminal device comprising:
a transmitting/receiving unit for receiving said information on said item, said bid price information, and said empty data which are transmitted from said server by wireless communication, and for transmitting bid command information when placing a bid on said item;
a display unit for displaying a bid price based on said information on said item and said bid price information which are received by said transmitting/receiving unit;
an input unit for designating said item and outputting said bid command information to said transmitting/receiving unit in order to place a bid on said item at said bid price displayed on said display unit; and
a communication maintaining unit for maintaining wireless communication with said server if it is determined that said empty data has been received by said transmitting/receiving unit.

7. (canceled)

8. The mobile terminal device according to claim 6, further comprising:
a current location detecting unit for detecting a current location of said mobile terminal device and for outputting current location information, wherein
said transmitting/receiving unit is configured to transmit said current location information output from said current location detecting unit to said server.

9. (canceled)

10. The wireless communication system according to claim 3, wherein said server is configured to determine a sum of said minimum sale price and a predetermined amount of money as said bid price if said server receives said bid command information from said mobile terminal device when said minimum sale price is being displayed on said display unit of said mobile terminal device.

11. The wireless communication system according to claim 1, wherein said empty data output unit is configured to transmit said empty data at predetermined time intervals until said auction is finished.

12. A wireless communication system for a registered user to wirelessly communicate with a server by using a mobile terminal device to search for an item put up for auction and place a bid, wherein
said server includes an information transmitting unit for transmitting information on said item put up for auction and bid price information to said mobile terminal device by wireless communication, and every time said item is changed, transmitting a bid price to said mobile terminal device,
said mobile terminal device includes
a transmitting/receiving unit for receiving said information on said item and said bid price information which are transmitted from said server by wireless communication, and for transmitting bid command information when placing a bid on said item,
a display unit for displaying said bid price based on said bid price information received by said transmitting/receiving unit, and
an input unit for designating said item and outputting said bid command information to said transmitting/receiving unit in order to place a bid on said item at said bid price displayed on said display unit,
said server is configured to transmit said bid price information and empty data at predetermined time intervals if it is determined that there is a possibility that it may be determined that communication has been suspended if said bid price information is transmitted at said predetermined time intervals or more, and to transmit only said bid price information if it is determined that there is no possibility that it may be determined that said communication has been suspended, and
said mobile terminal device is configured to maintain wireless communication with said server if it is determined that said empty data and said bid price information or only said bid price information has been received by said transmitting/receiving unit.

13. A method for searching for an item put up for auction and placing a bid by using a mobile terminal device that wirelessly communicates with a server, the method comprising:
receiving information on said item and bid price information which are transmitted from said server;
displaying a bid price based on said received information on said item and said received bid price information;
designating said item and outputting bid command information in order to place a bid on said item at said displayed bid price;
detecting a reception of empty data from said server by monitoring a communication status with said server; and
maintaining wireless communication with said server in response to the detection of said empty data.

14. A server for wirelessly communicating with a mobile terminal device, comprising:
an information transmitting unit for transmitting information on an item put up for auction and bid price information to said mobile terminal device by wireless communication, and every time said item is changed, automatically changing a bid price and transmitting said changed bid price to said mobile terminal device at predetermined time intervals; and
an empty data output unit for transmitting predetermined empty data to said mobile terminal device in order to maintain wireless communication with said mobile terminal device.
